(19) United States
(12) Patent Application Publication
(10) Pub. No.: US 2014/0143551 A1
(43) Pub. Date: May 22, 2014

(54) ENCODING BIOMETRIC IDENTIFICATION INFORMATION INTO DIGITAL FILES

(71) Applicant: Leigh M. ROTHSCHILD, Sunny Isles Beach, FL (US)

(72) Inventor: Leigh M. ROTHSCHILD, Sunny Isles Beach, FL (US)

(21) Appl. No.: 13/683,116

(22) Filed: Nov. 21, 2012

(51) Int. Cl. G06F 17/30; G06F 21/60

(52) U.S. Cl. CPC G06F 17/30345; G06F 21/602
USPC 713/189; 707/803

(57) ABSTRACT

A device, system and method for combining, by a processor, a digital content file with a first set of biometric data to create a combined file. The combined file is transmitted for reception at a destination. The first set of biometric data is compared against a second set of biometric data to verify a user. The system accesses the digital content file in response to verification of the user.

### CROSS-REFERENCE TO RELATED APPLICATION

n/a

### STATEMENT REGARDING FEDERALLY SPONSORED RESEARCH OR DEVELOPMENT

n/a

### FIELD OF THE INVENTION

The present invention relates to electronic file security, and in particular to using biometric data to encode and decode files.

### BACKGROUND OF THE INVENTION

The security of digital content files is increasingly important for both consumers and corporations alike. One problem is that secured files typically require knowledge of a password formed from a string of characters in order to gain access to the encrypted information. A challenge exists to secure digital content files using methods that do not require memorizing a password. The challenge further requires the ability to access the password at all times. For example, one may receive an encrypted file without being given the password key. In this case, the password must be learned before being able to access the encrypted file. This is particularly a problem because many users encrypt files using different passwords. This creates the additional problem that passwords become lost or forgotten, particularly following long time periods. As a result, important digital files may be rendered inaccessible.

Yet another problem with a password is that multiple individuals may have access to the password. For example, the password may be divulged to multiple individuals. This reduces the security of the file as multiple individuals gain knowledge of the password. As a result, the sensitive information may become compromised. In some cases the problem is exacerbated by the fact that one password may be used to secure multiple files. In such cases, an individual authorized for a particular file may inadvertently gain access to other sensitive files.

Another problem involves the transmission of secured content. It is not uncommon following a transmission of a secured file that the password is transmitted. Transmitting the password in a subsequent transmission allows the recipient to access the secured file. However, the subsequent transmission also compromises the contents of the secured file. For instance, in the event that the transmitted password is intercepted, the interceptor may have unrestrained access to the contents of the secured file.

### SUMMARY OF THE INVENTION

In accordance with one aspect, the present invention provides a method for combining, by a processor, a digital content file with a set of biometric data to create a combined file. The combined file is transmitted.

In accordance with yet another aspect, the present invention provides a method for allowing access to a received digital content file. A combined file is received in which the combined file includes a digital content file and a first set of biometric data. The first set of biometric data is compared against a second set of biometric data to verify a user. The digital content file is accessed in response to positive verification of the user.

According to another aspect, the present invention provides a device for accessing a protected combined file in which the combined file has a digital content file and a first set of biometric data. A receiver configured to receive the combined file. A storage element is configured to store a second set of biometric data. A processor is communicatively coupled with the receiver and the storage element. The processor is configured to allow a user to access the digital content file subsequent to verifying the user in which the user is verified based upon a comparison of the first and second set of biometric data.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 is a block diagram of an exemplary system constructed for encoding biometric identification information into digital files and decodes the digital files in accordance with the principles of the present invention;

FIG. 2 is a flow chart of an exemplary process for encoding biometric identification into digital files for transmission; and

FIG. 3 is a flow chart of an exemplary process for receiving and decoding biometric identification from digital files.

### DETAILED DESCRIPTION OF THE INVENTION

The present invention advantageously provides a system and method for combining a digital content file and a first set of biometric data defining a combined file, and receiving and decoding the combined file. In accordance with an embodiment of the present invention, the system and method allows for reliable and accurate access to a digital content file without a person's knowledge of a password.

Accordingly, the system and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

] Before describing in detail exemplary embodiments that are in accordance with the present invention, it is noted that the embodiments reside primarily in combinations of apparatus components and processing steps related to combining a digital content file and a first set of biometric data and receiving and decoding the combined file. Accordingly, the system and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

As used herein, relational terms, such as “first” and “second,” “top” and “bottom,” and the like, may be used solely to distinguish one entity or element from another entity or element without necessarily requiring or implying any physical or logical relationship or order between such entities or elements.

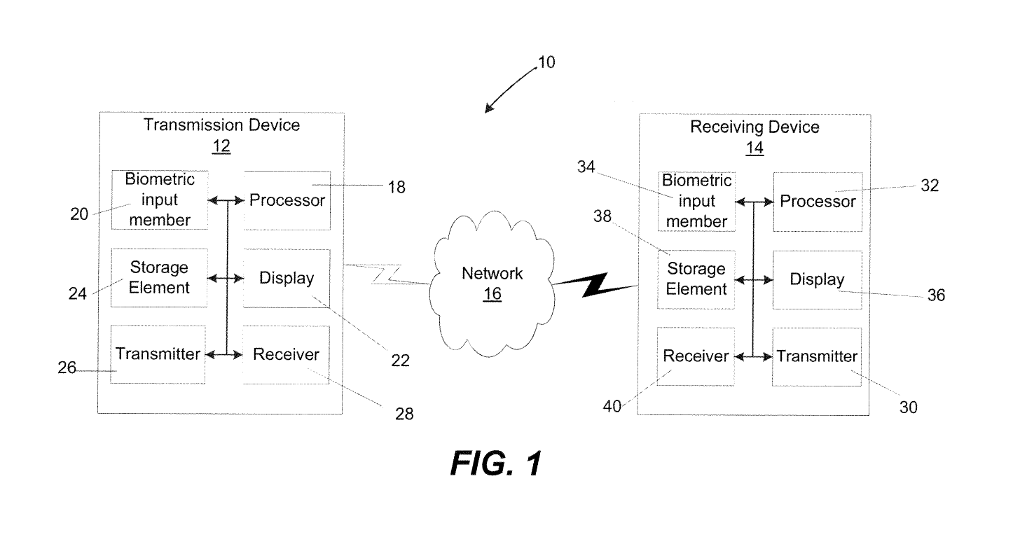

Referring now to the drawing figures in which like reference designators refer to like elements there is shown in FIG. 1 an exemplary embodiment constructed in accordance with the principles of the present invention and designated generally as “10.” As shown in FIG. 1, transmission device 12 and receiving device 14 may each be connected to network 16. Examples of network 16 include a cellular communication network and the Public Switched Telephone Network (PSTN), or other wide area network (WAN), such as the internet, as well as local area networks (LANS), such as an Ethernet LAN. Network 16 may additionally be a wireless network, such as Wi-Fi, satellite, infrared, Bluetooth, Near Field Communications, or other communication networks.

Transmission device 12 may be in communication with at least one other receiving device 14 over network 16, or otherwise capable of transmitting and receiving data. Transmission device 12 and receiving device 14 may each be a mobile device, personal computer, laptop computer, tablet computer or PDA, among other types of computing devices.

In an exemplary embodiment, transmission device 12 includes processor 18 in communication with biometric input member 20, display 22, storage element 24, transmitter 26 and receiver 28. It is contemplated that transmitter 26 and receiver 28 may be separate devices or otherwise be combined into a transceiver. Transmitter 26 transmits information over network 16. The information transmitted by transmitter 26 may be received by a receiver at the destination end of the transmission. Receiver 28 may receive confirmation that the information transmitted by the transmitter 26 was received by a receiver. For example, receiving device 14, discussed herein, may transmit by transmitter 30 a response that is received by receiver 28 of transmission device 12. The received message may indicate a successful transmission across network 16 by transmission device 12.

Receiving device 14 includes processor 32 in communication with biometric input member 34, display 36, storage element 38, receiver 40 and transmitter 30. It is contemplated that the transmitter 30 and receiver 40 may be an individual element or otherwise be combined into a transceiver. Receiver 40 receives information transmitted from network 16. The information received by receiver 40 may be transmitted by transmitter 26 in transmission device 12. Processors 18 and 32 may be of any type suitable for performing the functions described herein. Processors 18 and 32 may each include a central processing unit (CPU) programmed to perform the functions described herein with respect to transmission device 12 and receiving device 14. Processors 18 and 32 may each be configured to encrypt, decrypt, encode and decode digital data. Storage element 38 may be of any type of storage elements such as disk drives or cloud computing storage and the like. Storage element 38 may additionally include random access memory (“RAM”) and read only memory (“ROM”). Digital files may be stored in storage element 38.

Biometric input members 20 and 34 may each be standalone devices, may each be an integrated component of one of the displays 22 and 36, or alternatively biometric members 20 and 34 may be otherwise integrated into devices 12 and 14. Biometric input members 20 and 34 may be integrated into displays 22 and 36 for obtaining biometric data, e.g., a biometric hand, finger print or retinal scan. For instance, a tablet device display permits an individual's hand print to be read, which includes fingers, thumb and palm.

The biometric input members 20 and 34 may be configured to capture 3D biometric measurements. The 3D biometric measurements may include finger prints, hand prints and facial recognition scans, retinal scans among others. The biometric input member 20 may be any type of biometric sensor, presently known or developed in the future. For example, the biometric sensor may be a scanner, a camera, DNA analysis device or an inferred reader.

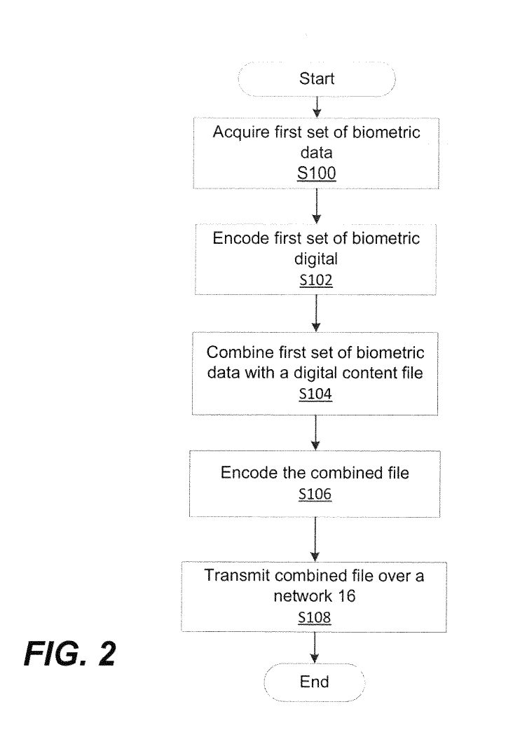

An exemplary process for creating a combined file, encoding at least a portion of the combined file and transmitting the combined file is described with reference to FIG. 2. Transmission device 12 is capable of requesting or otherwise receiving a first set of biometric data. Transmission device 12 acquires a first set of biometric data (Block S100). Processor 18 processes the received first set of biometric data or a first biometric data hash of the first set of biometric data. The biometric input member 20 may collect biometric data relating to fingerprints, hand prints, retina pattern, face detection and correlation patterns.

After receiving the first set of biometric data, the processor 18 may create a first biometric data hash of the first set of biometric data or otherwise encode the first set of biometric data (Block S102). The first set of biometric data is combined with a digital content file to create a combined file (Block S104). The combined file may be encoded based on the encoded first set of biometric data. Alternatively, the combined file may be encrypted based on the encoded first set of biometric data.

A threshold may be determined or otherwise acquired for preventing biometric impostors at any point during the acquisition of the first set of biometric data (Block S100), encoding of the first set of biometric data (Block S102), combining the first set of biometric data with a digital content file (Block S104) and encoding or encrypting the combined file based on the encoded first set of biometric data (Block S106). The threshold may be a measure or degree of similarity at which a match can be declared. The threshold need not declare based on an identical match, but instead based on a measurement of similarity. The threshold may be based on a threshold score of the comparison of the first set of biometric data with the second set used at the receiving end.

The combined file can be stored in the storage element 24 and/or the combined file can be transmitted over the network 16 to receiving device 14, or otherwise transmitted to a server or a cloud based computing service (Block S108).

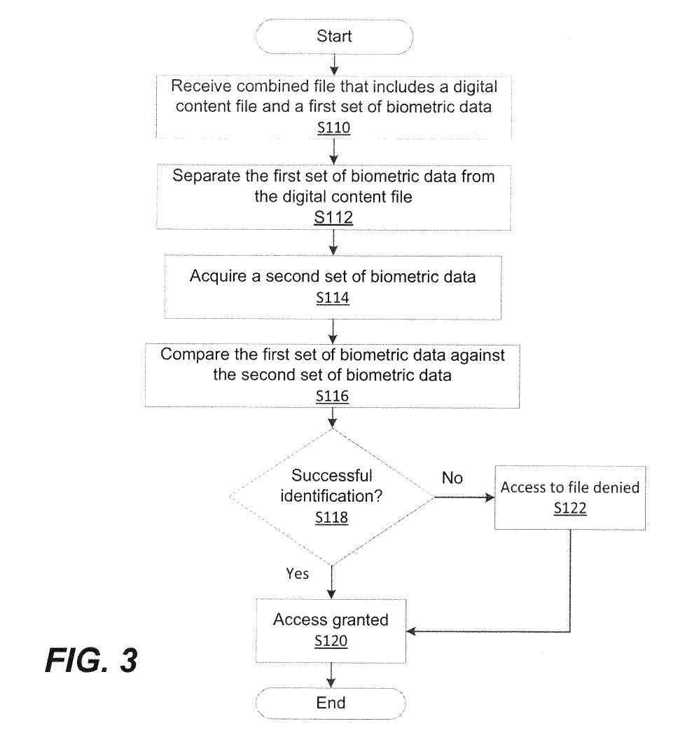

An exemplary process for receiving the combined file, decoding a combined file, and accessing the combined file is described with reference to FIG. 3. Receiving device 14 receives the combined file (Block S110). For example, the receiver 40 may receive the combined data over network 16. The processor 32 may write the combined file into storage element 38.

The first set of biometric data and the digital content file may be separated (Block S112). In an embodiment, it is contemplated that the first set of biometric data and the digital content file may be separated subsequent to receiving the combined file at Block S110. It is additionally contemplated in an alternative embodiment that the first set of biometric data and the digital content file may be separated subsequent to access being granted to the file at Block S120.

A request may be generated, via the processor 32, requesting a second set of biometric data. A second set of biometric data is acquired (Block S114). The second set of biometric data may be acquired through the biometric input member 34. Alternatively, the receiver 40 may receive the second set of biometric data. The second set of biometric data may be stored in a storage element 38 or be stored over the network 16 in a cloud based service. The second set of biometric data may be encoded to create a second biometric data hash.

The second biometric data hash is compared to the first biometric data hash (Block S116), via processor 32. Alternatively, the second biometric data hash is compared to the first biometric data hash (Block S116) via biometric input member 34 or over the network 16 via a cloud based computing device.

A determination is made as to whether the second set of biometric data matches the first set of biometric data based on a threshold matching value (Block S118). If the second biometric data hash is exceeds the threshold value of first biometric data hash, then access to the file is granted (Block S120). However, if the second biometric data hash is does not exceed the threshold value, then the comparison of the first and second sets of biometric data fails and access is denied (Block S122). The data file is decrypted subsequent to and only upon a successful comparison of the first and second set of biometric data.

In one embodiment, the first set of biometric data includes biometric measurements of at least two unique individuals. At least a portion of the first set of biometric data is compared against a second set of biometric data. In operation, this may be implemented to either reduce access or increase access to at least a portion of the combined file. For example, this embodiment may be implemented to increase access to the combined file by permitting multiple individuals to individually decode at least a portion of the combined file through their individual biometric measurements. As another example, biometric measurements from a single individual will not grant access to at least the portion of the combined file. Thus, the access to at least the portion of the combined file may be decreased by requiring a combination of biometric measurements from at least two individuals to create a second set of biometric data matching the first set of biometric data in order to decode at least a portion of the combined file.

In another embodiment, a successful comparison of the first and second set of biometric data provides access to only a portion of the combined file, i.e., only a designated portion is decoded and/or decrypted and made available to a verified, i.e., authenticated, user.

In a particular configuration, the second set of biometric data may include biometric measurements of only one individual. In this case, the second set of biometric data that includes biometric measurements of the one individual is compared against at least a portion of the first set of biometric data. At least a portion of the first set of biometric data may be matched to more than one individual. This increases the number of individuals that are permitted to individually access at least a portion of the combined file. Thus, more than one individual is capable of providing a second set of biometric data that matches at least a portion of the first set of biometric data. If the second set of biometric data match with at least a portion of the first set of biometric data exceeds a specified threshold value, access to the digital content of the combined file will be allowed. In operation, this permits multiple individuals to individually gain access the digital content of the combined file upon identification.

In another exemplary configuration, the second set of biometric data may include biometric measures of at least two individuals. In this case, the second set of biometric data that includes biometric measurements of at least two individuals is measured against the first set of biometric data. At least two biometric measurements of the second set of biometric data are compared against the first set of biometric data. This decreases access the contents of the combined file by requiring multiple individuals collectively provide a second set of biometric data in order to access at least a portion of the combined file. In one scenario, if at least two biometric measurements of the second biometric data match, based on a threshold value, at least a portion of the first set of biometric data, access to the digital content file is granted. In another embodiment, if at least one biometric measurement of the second biometric data match to the point where the match exceeds a threshold value when compared with the first set of biometric data, access to the digital content file is granted.

In accordance with principles described above, in a particular embodiment, transmission device 12 lacks the capability of communicating with a biometric input member 20. Alternatively, transmission device 12 acquires biometric data through other means than biometric input member 20. For example, transmission device 12 may receive a first set of biometric data over the network 16.

In yet another embodiment, biometric input members 20 and 34 may each be capable of detecting a measure of liveness of the biometric. For example, in order to determine whether the detected face of a subject is alive and not simply, among other things, a person's photograph, the biometric input member 20 may detect perspiration, head movements, electrical conductivity, detection of saccade, detection of papillary hippus, pupil dilation, temperature, skin tone in relation to lighting, light absorption characteristics, blink rate, extremity pulsation, pulse oximetry and changes in facial expression. Furthermore, biometric data relating to a voice may also include matching lip movement to the acquired voice metric.

It will be appreciated by persons skilled in the art that the present invention is not limited to what has been particularly shown and described herein above. In addition, unless mention was made above to the contrary, it should be noted that all of the accompanying drawings are not to scale. A variety of modifications and variations are possible in light of the above teachings without departing from the scope and spirit of the invention.

What is claimed is:

1. A method, comprising:
combining, by a processor, a digital content file with a first set of biometric data to create a combined file; and
transmitting the combined file.

2. The method of claim 1, further comprising:
encoding at least a portion of the combined file; and
encrypting at least a portion of the combined file to create an encrypted combined file,
wherein encrypting the combined file is based upon at least a portion of the first set of biometric data.

3. The method of claim 1, wherein the first set of biometric data includes biometric measurements of at least two users.

4. The method of claim 1, wherein the digital content file in the transmitted combined file can only be accessed by a user having biometric data matching the first set of biometric data.

5. A method, comprising:
receiving a combined file, the combined file including a digital content file and a first set of biometric data;
comparing the first set of biometric data against a second set of biometric data to verify a user; and
accessing the digital content file in response to positive verification of the user.

6. The method of claim 5, wherein the second set of biometric data includes biometric measurements of at least two users.

7. The method of claim 6, wherein accessing the digital content file is in response to verification of all of the at least two users.

8. The method of claim 5, wherein verification of the user is based on whether a threshold matching value has been exceeded for the comparison the first set of biometric data against the second set of biometric data.

9. The method of claim 5, wherein accessing the digital content file is in response to verification of one of the at least two users.

10. The method of claim 5, wherein only a portion of the digital content file is accessed in response to verification of the user.

11. A device for accessing a protected combined file, the combined file having a digital content file and a first set of biometric data, the device comprising:
a receiver configured to receive the combined file;
a storage element, the storage element configured to store a second set of biometric data; and
a processor communicatively coupled with the receiver and the storage element, the processor being configured to allow a user to access the digital content file subsequent to verifying the user, the user being verified based upon a comparison of the first and second set of biometric data.

12. The device of claim 11, wherein at least a portion of the combined file is encoded.

13. The device of claim 11, wherein at least a portion of the combined file is encrypted based at least in part on the first set of biometric data.

14. The device of claim 13, wherein the receiver receives the second set of biometric data.

15. The device of claim 14, further comprising a biometric identification module configured to compare the first and second set of biometric data, the processor decrypting the combined file subsequent to a successful comparison of the first and second set of biometric data.

16. The device of claim 11, further comprising a biometric sensor for acquiring the second set of biometric data, the biometric sensor being one of a scanner, a camera, an infrared reader and a DNA analysis device.

17. The device of claim 16, wherein the biometric sensor captures 3D biometric data.

18. The device of claim 16, wherein the biometric sensor determines a measure of liveness of second set of biometric data.

19. The device of claim 11, wherein the processor is further configured to allow access to the digital content file subsequent to verifying that the second set of biometric data in comparison to the first set of biometric data exceeds a predetermined threshold matching value.

20. The device of claim 11, wherein only a portion of the digital content file is accessed in response to verification of the user.

21. The device of claim 11, wherein the first set of biometric data and the second set of biometric data each include biometric measurements from at least two unique users; and
wherein accessing the digital content file requires verification of biometric measurements of the at least two users.

22. The device of claim 11, wherein the first set of biometric data includes biometric measurements from at least two unique users; and
wherein accessing the digital content file requires verification of the biometric measurement of at least one user of the at least two unique users.
